(19) United States
(12) Patent Application Publication
(10) Pub. No.: US 2005/0253777 A1
(43) Pub. Date: Nov. 17, 2005

(54) TILED DISPLAYS AND METHODS FOR DRIVING SAME

(75) Inventors: Robert W. Zehner, Arlington, MA (US); Werner Malcherek, Dachau (DE)

Correspondence Address: DAVID J COLE;E INK CORPORATION, 733 CONCORD AVE, CAMBRIDGE, MA, 02138-1002, US

(73) Assignees: E INK CORPORATION, Cambridge, MA (US); VOSSLOH INFORMATION TECHNOLOGIES KARLSFELD GMBH, Karlsfeld (DE)

(21) Appl. No.: 10/908,413

(22) Filed: May 11, 2005

Related U.S. Application Data
(60) Provisional application No. 60/570,254, filed on May 12, 2004.

(51) Int. Cl. G09G 5/00

(52) U.S. Cl. 345/1.3

(57) ABSTRACT

A tiled electro-optic display (100) comprises a plurality of display units (102) each of which can be individually removed from the display, and a controller (104, 110) arranged to supply drive signals to the plurality of display units (102) and thereby write images thereon, the electro-optic display (100) further comprising means (112) for modifying the drive signals supplied by the controller (104, 110) to reduce variation in electro-optic performance among the plurality of display units (102).

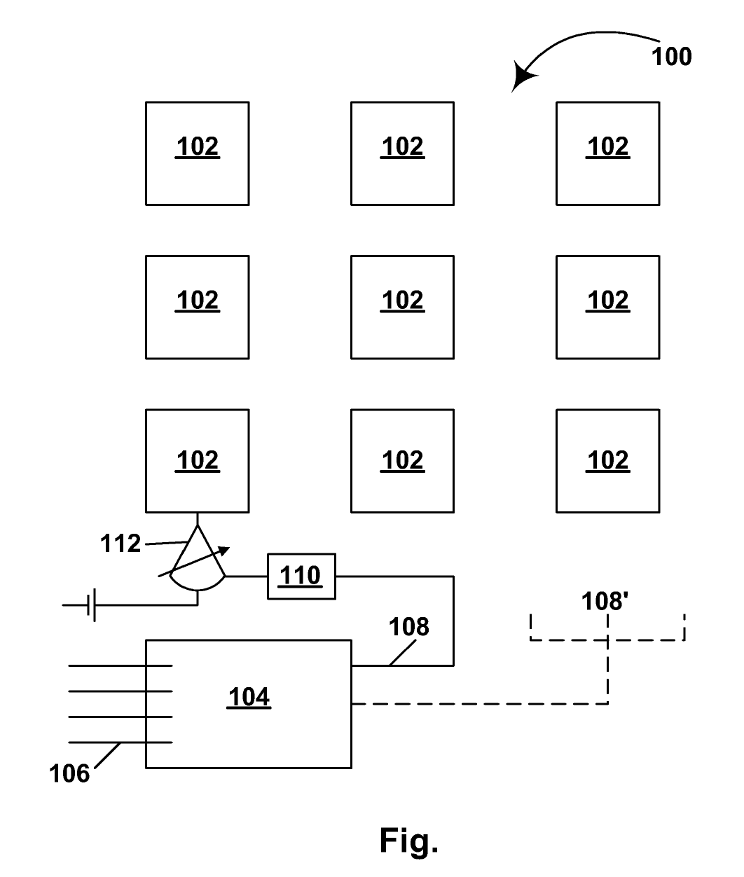

### REFERENCE TO RELATED APPLICATIONS

This application claims benefit of Provisional Application Ser. No. 60/570,254 filed May 12, 2004. The entire disclosure of this application, and of all U.S. patents and published and copending applications mentioned below, are herein incorporated by reference.

### BACKGROUND OF INVENTION

This invention relates to tiled displays, more specifically tiled electro-optic displays, and to methods for driving such displays.

The term “tiled displays” is used herein to refer to displays which are formed from a plurality of sub-units at least some of which can be replaced individually. The term does not imply that all the sub-units in such a display are identical, although obviously it is often convenient to use such identical sub-units.

Electro-optic displays comprise a layer of electro-optic material, a term which is used herein in its conventional meaning in the art to refer to a material having first and second display states differing in at least one optical property, the material being changed from its first to its second display state by application of an electric field to the material. The optical property is typically color perceptible to the human eye, but may be another optical property, such as optical transmission, reflectance, luminescence or, in the case of displays intended for machine reading, pseudo-color in the sense of a change in reflectance of electromagnetic wavelengths outside the visible range.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in published U.S. patent application No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Several types of electro-optic displays are known. One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791 (although this type of display is often referred to as a “rotating bichromal ball” display, the term “rotating bichromal member” is preferred as more accurate since in some of the patents mentioned above the rotating members are not spherical). Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed to applying an electric field thereto, thus rotating the bodies to various positions and varying which of the sections of the bodies is seen through a viewing surface. This type of electro-optic medium is typically bistable.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. No. 6,301,038, International Application Publication No. WO 01/27690, and in U.S. patent application 2003/0214695. This type of medium is also typically bistable.

Another type of electro-optic display, which has been the subject of intense research and development for a number of years, is the particle-based electrophoretic display, in which a plurality of charged particles move through a suspending fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

Numerous patents and applications assigned to or in the names of the Massachusetts Institute of Technology (MIT) and E Ink Corporation have recently been published describing encapsulated electrophoretic media. Such encapsulated media comprise numerous small capsules, each of which itself comprises an internal phase containing electrophoretically-mobile particles suspended in a liquid suspending medium, and a capsule wall surrounding the internal phase. Typically, the capsules are themselves held within a polymeric binder to form a coherent layer positioned between two electrodes. Encapsulated media of this type are described, for example, in U.S. Pat. Nos. 5,930,026; 5,961,804; 6,017,584; 6,067,185; 6,118,426; 6,120,588; 6,120,839; 6,124,851; 6,130,773; 6,130,774; 6,172,798; 6,177,921; 6,232,950; 6,249,271; 6,252,564; 6,262,706; 6,262,833; 6,300,932; 6,312,304; 6,312,971; 6,323,989; 6,327,072; 6,376,828; 6,377,387; 6,392,785; 6,392,786; 6,413,790; 6,422,687; 6,445,374; 6,445,489; 6,459,418; 6,473,072; 6,480,182; 6,498,114; 6,504,524; 6,506,438; 6,512,354; 6,515,649; 6,518,949; 6,521,489; 6,531,997; 6,535,197; 6,538,801; 6,545,291; 6,580,545; 6,639,578; 6,652,075; 6,657,772; 6,664,944; 6,680,725; 6,683,333; 6,704,133; 6,710,540; 6,721,083; 6,724,519; 6,727,881; 6,738,050; 6,750,473; 6,753,999; 6,816,147; 6,819,471; 6,822,782; 6,825,068; 6,825,829; 6,825,970; 6,831,769; 6,839,158; 6,842,167; 6,842,279; 6,842,657; 6,864,875; 6,865,010; 6,866,760; and 6,870,661; and U.S. patent applications Publication Nos. 2002/0060321; 2002/0063661; 2002/0090980; 2002/0113770; 2002/0130832; 2002/0180687; 2003/0011560; 2003/0020844; 2003/0025855; 2003/0102858; 2003/0132908; 2003/0137521; 2003/0151702; 2003/0214695; 2003/0222315; 2004/0012839; 2004/0014265; 2004/0027327; 2004/0075634; 2004/0094422; 2004/0105036; 2004/0112750; 2004/0119681; 2004/0136048; 2004/0155857; 2004/0180476; 2004/0190114; 2004/0196215; 2004/0226820; 2004/0233509; 2004/0239614; 2004/0252360; 2004/0257635; 2004/0263947; 2005/0000813; 2005/0001812; 2005/0007336; 2005/0007653; 2005/0012980; 2005/0017944; 2005/0018273; 2005/0024353; 2005/0035941; 2005/0041004; 2005/0062714; and 2005/0067656; and International Applications Publication Nos. WO 99/67678; WO 00/05704; WO 00/38000; WO 00/36560; WO 00/67110; WO 00/67327; WO 01/07961; and WO 03/107,315.

Electrophoretic displays may be capable of intermediate gray states having optical characteristics intermediate the two extreme optical states already described.

Some of the aforementioned patents and published applications disclose encapsulated electrophoretic media having three or more different types of particles within each capsule. For purposes of the present application, such multi-particle media are regarded as sub-species of dual particle media.

Also, many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

An encapsulated, electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; and other similar techniques.) Thus, the resulting display can be flexible. Further, because the display medium can be printed (using a variety of methods), the display itself can be made inexpensively.

A related type of electrophoretic display is a so-called “microcell electrophoretic display”. In a microcell electrophoretic display, the charged particles and the suspending fluid are not encapsulated within capsules but instead are retained within a plurality of cavities formed within a carrier medium, typically a polymeric film. See, for example, International Application Publication No. WO 02/01281, and published U.S. application No. 2002/0075556, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, the aforementioned U.S. Pat. Nos. 6,130,774 and 6,172,798, and U.S. Pat. Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

As noted above, electrophoretic media require the presence of a suspending fluid. In most prior art electrophoretic media, this suspending fluid is a liquid, but electrophoretic media can be produced using gaseous suspending fluids; see, for example, Kitamura, T., et al., “Electrical toner movement for electronic paper-like display”, Asia Display/IDW '01 (Proceedings of the 21st International Display Research Conference in conjunction with The 8th International Display Workshops, Oct. 16-19, 2001, Nagoya, Japan), page 1517, Paper HCS1-1, and Yamaguchi, Y., et al., “Toner display using insulative particles charged triboelectrically”, Asia Display/IDW '01, page 1729, Paper AMD4-4. See also European Patent Applications 1,429,178; 1,462,847; 1,482,354; and 1,484,625; and International Applications WO 2004/090626; WO 2004/079442; WO 2004/077140; WO 2004/059379; WO 2004/055586; WO 2004/008239; WO 2004/006006; WO 2004/001498; WO 03/091799; and WO 03/088495. Such gas-based (“GB”) electrophoretic media appear to be susceptible to the same types of problems due to particle settling as liquid-based electrophoretic media, when the media are used in an orientation which permits such settling, for example in a sign where the medium is disposed in a vertical plane.

Encapsulated electrophoretic and certain other types of electro-optic displays can be made light in weight, easy to read under a variety of lighting conditions, and have low power consumption per unit area, especially having regard to their bistability, since a bistable display only draws power when the image thereon is being rewritten (or refreshed, if an single image has to be displayed for so long a period that the quality of the displayed image begins to decline). These advantages render such displays very suitable for large area displays, for example billboard type displays or large data displays for use in sports stadia or airports or railroad stations. It is convenient to form such large area displays by tiling together a number of sub-units; see, for example, the aforementioned U.S. Pat. No. 6,252,564. Two key advantages accrue from such a modular design. First, many different display configurations can be formed by assembling tiles or modules in different arrangements. Second, if a single module fails, it can be replaced in the field, at a much lower cost than replacing the entire display.

Such large area displays typically have a complex hierarchy of physical elements, signals and controllers. The sub-units or individual tiles may contain a certain number of pixels, or one or more characters in the case of a segmented, starburst or mosaic display. These tiles are then connected together, physically and electronically, to create a single display. The display will typically be addressed by a single controller, which may or may not distribute signals to “line controllers”, which address individual lines or portions of the display. In turn, the signals may then be applied directly to the display elements, or may be used as control signals for display drivers, or may be further interpreted and processed by separate controllers for each module or tile.

In such large area displays, it is important that all the tiles have substantially the same electro-optic properties, for example substantially the same white state and contrast ratio, since the human eye is very sensitive to variations in electro-optic properties within a single display. However, maintaining consistent electro-optic properties within a large area display, comprising individually replaceable tiles, presents problems. Many electro-optic media “age”, that is to say their electro-optic properties gradually change with time since manufacture and/or with operating time. Thus, if a few tiles within a large area display are replaced after the sign has been operating for months or years, the newly-installed tiles may have visibly different electro-optic properties from the older tiles. As another example, in a large display the temperature may vary substantially from one end of the display to the other, and the performance of the electro-optic medium may vary accordingly. Adjusting the performance of individual tiles (of which there may be 100 or more) to account for these factors would be an extremely complex task for the central controller.

The present invention relates to methods for modifying the drive signals provided to individual tiles within a tiled display in order to reduce variation in electro-optic performance between tiles. The present invention also relates to tiled signs provided with means for carrying out such methods.

### SUMMARY OF INVENTION

Accordingly, in one aspect, this invention provides a tiled electro-optic display comprising a plurality of display units each of which can be individually removed from the display, and a controller arranged to supply drive signals to the plurality of display units and thereby write images thereon, the electro-optic display further comprising means for modifying the drive signals supplied by the controller to reduce variation in electro-optic performance among the plurality of display units.

In one form of such a tiled display, the modifying means may comprise an amplifier with adjustable gain provided between a power supply and each of the plurality of display units. At least one amplifier may be provided with adjustment means for adjusting its gain with time. Alternatively, at least one amplifier may be provided with a timer arranged to measure the total operating time of its associated display unit, and amplifier control means for adjusting the gain of the amplifier dependent upon the operating time measured by the timer.

In a second form of a tiled display of the present invention, the modifying means may comprise means for varying the lengths of drive pulses supplied to each display unit. The means for varying the lengths of drive pulses may comprise means for generating a start signal that activates an output enable signal on all the display units, and a control circuit associated with each display unit, the control circuit being arranged to terminate the output enable signal to its associated display unit after a controlled period. At least one control circuit may comprise a comparator having one input arranged to receive the start signal and a second input arranged to receive the output of an integrating circuit.

In a third form of a tiled display of the present invention, the modifying means may comprise means for varying the drive voltage applied to the pixels of each display unit. The means for varying the drive voltage may comprise a voltage modulated drive circuit.

In a fourth form of a tiled display of the present invention, the modifying means may comprise a unit controller associated with each display unit, each unit controller having stored therein a plurality of look-up tables defining the waveforms required for each transitions between gray levels of a pixel of the associated display unit, and means for generating a selection signal representing which one of the stored look-up tables are to be used by the unit controller to determine the waveforms to be applied to the associated display unit.

As discussed in several of the E Ink and MIT patents and applications mentioned above, the electro-optic characteristics of electro-optic displays may be affected by certain, such as temperature and light level, and the electro-optic displays of the present invention may be equipped to compensate for the effects of such environmental parameters. Thus, for example a display of the present invention may comprise a temperature sensor arranged to generate a temperature signal representative of the temperature of the electro-optic display, and to supply this temperature signal to the modifying means. Alternatively or in addition, such a display may comprise a light sensor arranged to generate a light signal representative of the light level at the electro-optic display, and to supply this light signal to the modifying means.

### BRIEF DESCRIPTION OF DRAWINGS

The sole FIGURE of the accompanying drawings is a schematic illustration of an electro-optic display according to the first aspect of the present invention.

### DETAILED DESCRIPTION

As already indicated, the present invention relates to modifying the drive signals supplied by a controller to the various display units (“tiles”) of a tiled electro-optic display in order to reduce variation in electro-optic performance among the display units. The modification of the drive signals can be effected in several different ways, and optionally the tiled electro-optic display may include means for further adjusting the drive signals to take account of environmental or other parameters which affect the electro-optic performance of the display.

In one aspect, this invention provides for the drive voltages supplied to each tile to be modified to reduce variation in electro-optic performance among tiles. The drive voltages may be adjusted by, for example, inserting operational amplifiers with adjustable gain (preferably with a gain less than or equal to 1) between power supplies and the individual tile inputs, so that the actual voltage applied to a given tile is equal to the power supply voltage multiplied by the amplifier gain. The amplifier may be provided with means for automatically adjusting its gain as its associated tile ages. For example, some electro-optic media undergo a relatively rapid change in electro-optic properties during the first part (less than 10 per cent) of their operating life and a much slower change in electro-optic properties during the remainder of their operating life. The amplifier may be provided with a counter arranged to measure the total operating time of its associated tile, and control means for adjusting its gain with operating time to compensate for the known changes in the electro-optic properties of the electro-optic medium with operating time.

In a second aspect, this invention provides for the pulse length applied to each tile to be modified to reduce variation in electro-optic performance among tiles. The pulse lengths may be adjusted by, for example, sending a “start” signal to every tile that activates an output enable (OE) signal on a driver. The OE signal may then be deactivated after the desired time by a control circuit in each individual tile. An example of such a control circuit would be a comparator with one input driven by the start signal, and the other input driven by an integrating circuit. By changing the input voltage or proportionality constant of the integrating circuit, the time for the output of the integrating circuit to exceed the voltage of the start signal could be adjusted, thus changing the length of the applied pulse.

In a third aspect, this invention provides for the drive voltage supplied to the pixels in the display to be modified to reduce variation in electro-optic performance. Such adjustment of the drive voltage may be accomplished, for example, by using a voltage-modulated (VM) driver integrated circuit (IC), and adjusting the data input to change the resulting output voltage. As an example, the data input to the driver IC could be derived by ANDing the value of a single data input containing pixel on-off data with the values encoded on a DIP switch, then clocking these values into the data registers of the IC.

A fourth aspect of the invention relates to displays in which the output of each tile is controlled by a controller as previously described (for example, in the aforementioned 2003/0137521), which uses a look-up table to determine the waveform to be applied to a specific pixel in order to effect a given transition. The fourth aspect of the present invention provides for the modification of such a look-up table (LUT) that dictates the time-dependent outputs of the drivers. The look-up table may be modified to include adjustments to pulse shape, amplitude and duration. As an example, the controller may be provided with 8 input lines, and the 8-bit input received on such lines interpreted as an index to choose one LUT from 256 possible ones. For example, the 8 input lines could be connected to the output of an analog/digital (A/D) converter reading the analog value of a voltage divider circuit adjusted by a potentiometer.

Each of these four approaches may be used to adjust for differences in optical response or performance between tiles. For example, an installation technician could adjust a potentiometer or DIP switch setting on a tile to increase or decrease the applied pulse length or voltage used by that tile. A replacement tile might be supplied with a lower voltage or shorter pulse length, for example, to match the performance of an older neighboring tile with decreased performance. In another example, the necessary values could be set by a semi-automated system that measures the optical performance of a tile and adjusts one or more control parameters to match the optical performance to a set of reference values. Alternatively, these values could be encoded on to each tile at the time of its production, for example via digital potentiometers, resistor trimming, mask ROM, or writing the values to a flash ROM.

All four aspects of the present invention permit modification of the drive pulses applied to the pixels of the display units in response to environmental and other parameters, the pulse length, voltage or LUT may be modified based upon the value of an input or counter, for example, a temperature sensor, a light sensor, a timer, or an update counter. The modification may be performed by processing the input(s) using digital logic, or by constructing an analog circuit with the desired input/output relationship, thus allowing the drive signal to be adjusted as a function of, for example, temperature, lighting level, operating time, or number of changes in the displayed image on the display unit, to maintain or optimize the electro-optical performance of each tile. There could be one of each type of sensor or counter per tile, or one sensor of a given type may be shared by two or more tiles.

The sole FIGURE of the accompanying drawings illustrates, in a highly schematic manner, a display (generally designated 100) according to the first aspect of the present invention. The display 100 comprises an array of display units or tiles 102; a 3×3 array is illustrated although in practice a larger number of tiles would typically be used. The display 100 further comprises a central controller 104 having an input bus 106 which receives data representing an image which is to be displayed on the entire display 100. The central controller 104 is provided with output lines which feed to each tile 102 data representing the portion of the image to be displayed on that tile. For ease of illustration, The FIGURE shows only the auxiliary apparatus (as described below) associated with one of the tiles 102 (the lower left tile as illustrated in the FIGURE), but it will be understood that each of the tiles 102 is provided with such auxiliary apparatus. The output line associated with the lower left tile 102 is designated 108, while the output lines associated with the other tiles are illustrated schematically at 108′.

As shown in the FIGURE, output line 108 extends from the central controller 104 to the input of a unit controller 110 associated with an individual tile 102. The output from unit controller 110 is fed to a variable amplifier 112, the output from which is fed via row and column drivers (not shown) to the pixels of the associated tile 102.

As discussed in the aforementioned 2003/0137521 and other published E Ink applications mentioned above, converting an image provided as in a computer-readable format to the series of drive pulses needed to drive individual pixels of an electro-optic display, such as the display 100 shown in the FIGURE, is typically a complicated, multi-step process. Typically, a pre-processing step is needed to convert the image file supplied into a form required by the display; for example, it may be necessary to convert a non-bitmap (metafile) format to a bitmap format, to decompress a compressed bitmap format, or to scale the number of pixels or the gray scale depth of the supplied image to match the capabilities of a particular display. After the image is in a format usable by the electro-optic display, it is necessary to compare the desired gray level for each pixel of the image with the corresponding gray level of the same pixel in the image previously displayed (and possibly with other previous images), and to determine the appropriate waveform for the transition to be undergone by that pixel. The selected waveform may then need to be modified to take account of environmental parameters such as display temperature, humidity and light level, and possibly other parameters such as remnant voltage and electro-optic medium operating lifetime. Finally, the modified waveform is used to general a series of drive pulses (i.e., periods when particular voltages are applied to the given pixel).

As will readily be apparent to those skilled in data processing technology, which of these multiple image processing steps are effected by the central controller 104 and which by the unit controllers 110 is to be a large extent arbitrary, and may vary with, for example, number of tiles in a particular display and the data processing capabilities of the specific circuitry used for the central and unit controllers. Indeed, in theory the unit controllers 110 could be eliminated and all data processing handled by the central controller 104, although this is typically undesirable because of the need for the central controller 104 to maintain data (and possibly to receive sensor readings) from the numerous tiles 102. In practice, it will generally be convenient for the central controller 104 to carry out image processing to the point at which the desired gray level of each pixel of the display 100 is defined, and to pass to each unit controllers 110 data defining the desired gray level of each pixel of its associated tile, with the unit controllers 110 converting this gray level data to the drive pulses needed to achieve the specified gray levels.

The variable gain of the amplifier 112 may be controlled by a timer which measures the operating time of the associated tile 102. Optionally, the amplifier 112 may also receive inputs from sensors measuring one or more of the temperature, ambient humidity and light level of the display 100.

It will readily be apparent that numerous changes and modifications can be made in the embodiment of the invention shown in the FIGURE. For example, the variable amplifier could be eliminated and the necessary adjustment of the drive voltage effected digitally be the unit controller 110, using a voltage modulated driver in accordance with the third aspect of the present invention. The necessary modifications of the apparatus to adapt it for use in the second and fourth aspects of the present invention will also readily be apparent to those skilled in the technology of electro-optic displays.

Numerous other changes and modifications can be made in the preferred embodiments of the present invention already described without departing from the spirit and scope of the invention. Accordingly, the whole of the foregoing description is to be construed in an illustrative and not in a limitative sense.

1. A tiled electro-optic display comprising a plurality of display units each of which can be individually removed from the display, and a controller arranged to supply drive signals to the plurality of display units and thereby write images thereon, the electro-optic display further comprising means for modifying the drive signals supplied by the controller to reduce variation in electro-optic performance among the plurality of display units.

2. A tiled electro-optic display according to claim 1 wherein the modifying means comprises an amplifier with adjustable gain provided between a power supply and each of the plurality of display units.

3. A tiled electro-optic display according to claim 2 wherein at least one amplifier is provided with adjustment means for adjusting its gain with time.

4. A tiled electro-optic display according to claim 2 wherein at least one amplifier is provided with a timer arranged to measure the total operating time of its associated display unit, and amplifier control means for adjusting the gain of the amplifier dependent upon the operating time measured by the timer.

5. A tiled electro-optic display according to claim 1 wherein the modifying means comprises means for varying the lengths of drive pulses supplied to each display unit.

6. A tiled electro-optic display according to claim 5 wherein the means for varying the lengths of drive pulses comprises means for generating a start signal that activates an output enable signal on all the display units, and a control circuit associated with each display unit, the control circuit being arranged to terminate the output enable signal to its associated display unit after a controlled period.

7. A tiled electro-optic display according to claim 6 wherein at least one control circuit comprises a comparator having one input arranged to receive the start signal and a second input arranged to receive the output of an integrating circuit.

8. A tiled electro-optic display according to claim 1 wherein the modifying means comprises means for varying the drive voltage applied to the pixels of each display unit.

9. A tiled electro-optic display according to claim 8 wherein the means for varying the drive voltage comprises a voltage modulated drive circuit.

10. A tiled electro-optic display according to claim 1 wherein the modifying means comprises a unit controller associated with each display unit, each unit controller having stored therein a plurality of look-up tables defining the waveforms required for each transitions between gray levels of a pixel of the associated display unit, and means for generating a selection signal representing which one of the stored look-up tables are to be used by the unit controller to determine the waveforms to be applied to the associated display unit.

11. A tiled electro-optic display according to claim 1 further comprising a temperature sensor arranged to generate a temperature signal representative of the temperature of the electro-optic display, and to supply this temperature signal to the modifying means.

12. A tiled electro-optic display according to claim 1 further comprising a light sensor arranged to generate a light signal representative of the light level at the electro-optic display, and to supply this light signal to the modifying means.
